(19) United States
(12) Patent Application Publication
(10) Pub. No.: US 2009/0119002 A1
(43) Pub. Date: May 7, 2009

(54) Terminal For Satellite Navigation System

(75) Inventors: Jan M.W. Krueger, Konstanz (DE); Hans L. Trautenberg, Ottobrunn (DE)

Correspondence Address: CROWELL & MORING LLP;INTELLECTUAL PROPERTY GROUP, P.O. BOX 14300, WASHINGTON, DC, 20044-4300, US

(73) Assignee: Astrium GmbH, Muenchen (DE)

(21) Appl. No.: 12/064,442

(22) PCT Filed: Aug. 10, 2006
(86) PCT No.: PCT/EP2006/007911

§ 371 Date: Jul. 29, 2008

(30) Foreign Application Priority Data
Aug. 22, 2005 (DE) 10 2005 039 807.3

(51) Int. Cl. G01S 1/00

(52) U.S. Cl. 701/200

(57) ABSTRACT

A terminal for satellite navigation services includes a first receiver for receiving navigation messages emitted by satellites; an output interface for the output of navigation information; and an activating unit.

In response to a command signal contained in a navigation message, the activating unit changes an operating condition of the terminal.

This application is a national stage application of PCT International Application No. PCT/EP2006/007911, filed Aug. 10, 2006, which claims priority under 35 U.S.C. §119 to German Patent Application No. 10 2005 039807.3, filed Oct. 2, 2006, the entire disclosure of which is herein expressly incorporated by reference.

### BACKGROUND AND SUMMARY OF THE INVENTION

The present invention relates to satellite navigation systems, and the information transmission by means of satellite navigation systems. In this context, the invention particularly relates to a terminal for a satellite navigation service, including a first receiver for receiving navigation messages emitted by satellites and an output interface for the output of navigation information.

Satellite navigation systems are increasingly used for transmitting navigation messages for position indicating or for navigation, in the narrow sense of the word, to terminals which are part of the satellite navigation system. With the broadening of the use of satellite navigation services, in addition to commercial users, such as air lines, shipping lines, etc., increasingly private users are also served, for example, private pilots, automobile drivers, motorcyclists, bicyclists, pedestrians, leisure captains, etc. The navigation messages emitted by the satellite typically contain only data required for position determination or navigation (hereinafter referred to as “navigation information”). Such navigation information is received by the terminal, which computes the actual position, speed, etc. from the navigation information of different satellites.

The latter information is indicated to the user in a more or less processed manner. For this purpose, the output interface typically transmits the corresponding navigation information to a monitor which may be a component of the terminal. The navigation information is frequently combined, for example, with information stored in the terminal (such as map information, etc.) to create an attractive display for the user. An alternative to the visual display (for example, by way of a monitor) is an acoustic indication. Visual and an acoustic indications may be of course combined with one another.

Navigation messages from the satellites must be repeated at relative short intervals, (for example, on a 30-second cycle), in order to ensure sufficient precision and integrity. The available bandwidth emitted by the satellite is correspondingly coordinated so that it is virtually used up by the emitted navigation information.

On the other hand, there is a need to disseminate certain information as widely as possible, such as warnings of catastrophes, tsunamis, storms, etc. It is relatively easy to spread this type of information in densely populated areas. Problems arise, however in areas with fewer inhabitants and in remote regions. The transmission of such warnings by radio and television is one possibility. However, this method is not sufficient because it does not reach all people concerned.

Therefore, one object of the invention is to provide an additional communication path for transmitting information.

This and other objects and advantages are achieved by the terminal according to the invention for the use in satellite navigation services, which has an activating unit that is constructed so that it changes an operating state in response to a command signal contained in a navigation message.

The command signal may be a pure command signal, such as a signal that ensures that a message stored in the terminal is communicated to the user by way of the output interface. Alternatively, or in addition, the command signal may contain information data (for example, a text message), and the terminal is designed such that, when a text message is received, it is automatically transmitted to the user by way of the output interface. For example, when the information is output via a video screen, it can be communicated to the user in a screen-filling manner in place of the navigation information. As another alternative, the information can be transmitted parallel to the navigation information in a portion of the video screen (for example, as a continuously running band). The terminal may be constructed such that it implements only one of these display modes, or as an alternative, specific command signals, either emitted by the satellite together with the information data or stored in the terminal, may indicate which display mode is to be used.

The terminal may also include a second receiver for receiving information data, which is activated by command signals contained in the navigation message. It may be designed so that it receives messages from an information transmitter, such as a ground station or a satellite for the information transmission, and transmits these messages, for example, to the user. Such transmission may take place, for example, by way of the output interface. A separate channel for the output of such information may also be provided. The second receiver may, for example, be coupled with the activating unit so that, as a result of the received command signal, the second receiver device is activated, and preferably a frequency or a channel for the second receiver device is also selected on which the corresponding information data are transmitted.

The second receiver may be an element of a communication device which is constructed such that it can actively query information data from outside the terminal. For example, the second receiver may be the receiving part of a communication device which communicates with the internet. This arrangement is preferred because it requires only a very small bandwidth for the command signals. It is sufficient to transmit command signals together with the navigation messages which contain an internet address or replace such an internet address. The latter may, for example, be stored in the terminal, so that, upon receiving a corresponding command signal, the communication device establishes contact with the internet or the distant terminal, and transmits the information data to be transmitted, by way of the second receiver. The advantage of providing the second receiver for receiving information data is that the bandwidth during the transmission by way of the second receiver device can be significantly higher than the bandwidth that can be made available by the satellite navigation system. Another application for the internet contact is, for example, a communication device which dials itself under a certain predetermined telephone number similar to the internet address into the telephone network (for example, a fixed network, mobile radio communication, or a mobile telephone), and thereby can query and obtain the information data from outside the terminal.

The terminal may have a user input module, and it may be advantageous to design the activating device such that, after a change of the operating state of the terminal, the activating device changes back into the normal operation only in response to a signal of the user input module. Thus, a function can be implemented during which the user first has to acknowledge the change of the operating condition (thus, for example, the receipt of certain information data), before he can use the terminal again in the customary manner for using navigation services.

The terminal may have a memory for storing command signals and/or information data transmitted together with the navigation messages. For example, the activation unit can be connected with a timer such that defined information data that are not highly relevant are displayed only a certain time after the switching-on of the terminal. Thus, after switching on the terminal user first has the opportunity to use the navigation services, and the command signal changes the operating condition of the terminal (or the corresponding information is indicated) only after a certain time. A timer can also be used in order to delete the displayed information after a predetermined time period.

The activating unit may be designed to manage the storing of the information data or the command signals into the memory, and the terminal may be designed to deactivate or delete the information data or the command signals automatically after a certain time.

The activating unit may be constructed so that it selects certain user groups in a targeted manner or responds only to certain command signals, as a function of the speed of the terminal determined by the terminal. If, for example, a terminal is moving at a speed of over 300 km/h for an extended period of time, it can be assumed that it is an airplane. Accordingly, messages can be selected which are directed only to users in an airplane. If, on the other hand, a terminal is moving at a speed of about (or below) 7 km/h, it can be assumed that hikers, walkers, etc. are involved, and only that information that is of interest to this user group will correspondingly be selected. Like speed, the position can also be used for select information. Thus, in the case of a tsunami warning, the information may be limited to coastal areas. Likewise, in the case of a position, for example, on a lake or on the ocean, those user groups that are to receive nautical information or command signals may be selected in a targeted manner.

The invention further relates to a satellite navigation system having several satellites for emitting navigation messages, at least one terminal and a ground station that is in contact with the satellite. The ground station may have a selecting device which can select satellites that momentarily service a certain geographical region on the ground, so that the navigation message of at least some of these satellites contains a command signal can change the operating condition of a terminal in this region. In this manner, by a selection of the satellites, it can be ensured that the transmission of corresponding information only to or for these satellites is spatially limited.

The invention further relates to a method of changing an operating condition of a terminal in a satellite navigation system, having the following steps:

(a) Generating a command signal;

(b) Transmitting the command signal to at least one satellite of the satellite navigation system;

(c) Incorporating the command signal into the navigation message of the satellite;

(d) Transmitting the navigation message containing the command message to the terminal; and

(e) Changing the operating condition of the terminal in response to the command signal.

Changing the operating condition of the terminal in response to the command signal may also include downloading software updates onto the terminal. Such software may, for example, be transmitted in many small portions together with the navigation message. As an alternative, it may be queried from the outside, for example, by way of the second receiver device. Changing the operating condition of the terminal in response to the command signal may also include taking it out of service if for example, it is out-of-date and no longer corresponds to current requirements, or if the agreed utilization time has expired.

The method may also include a step of selecting one or more satellites based on the target group to be reached. In this case, the satellite can, on the one hand, be selected by the ground station, so that only the one or more satellites, which are just servicing the target region, transmit the corresponding command signal. On the other hand (or in addition), this can also take place in that the terminal takes into account and processes the command signals of a limited group of satellites, for example, the satellite or satellites which at the time are situated the highest above the terminal. This selection can be carried out, for example, by means of the activating unit.

The step of changing the operating condition of the terminal may include the step of emitting information data to the user, including the emission of information data instead of, or in addition, to the navigation data.

The step of changing the operating condition of the terminal may include the step of receiving information data, particularly from an external information source, or from an information source which is independent of the satellites of the satellite navigation system. This may, for example, be the step of actively fetching the information data from an external information data source.

The method may also include the step of resuming the normal operation of the terminal after a change of the operating condition of the terminal, only after the user has acknowledged the change of the operating condition, and thus confirmed the receipt of the information.

The method may also include the step of checking the speed of the terminal and the changing of the operating condition as a function of the speed of the terminal.

The invention further relates to a navigation message which is emitted by a satellite of a navigation system and, in addition to the pure navigation data, has at least one command signal for changing the operating condition of the terminal. A navigation message is typically constructed in page frames. Thus, a navigation message may, for example, have 30 page frames, in which case, for example, page frames 1 to 15 are regularly used for the actual navigation operation. Then, for example, pages frames 16 and 17 can be used for to transmit the command signal or of the command signal and the corresponding information data. As mentioned above, the bandwidth for the transmission of the information via the satellite of the satellite navigation system is relatively small. Subframes 16-1, 16-2, . . . , 16-n and 17-1, 17-2, . . . , 17n can therefore be defined which are transmitted in n successive navigation messages. Alternatively (or in addition), it may be possible to transmit individual command signal packets by way of different satellites. For example, different satellites may emit the page subframes 16-1, . . . , 16-n and 17-1, . . . , 17-n in a time-shifted manner, so that, for example, in the case of two satellites, the information arrives at the terminal in half the time or, in the case of three satellites, in a third of the time, etc. The individual command signal packets can then be assembled to the complete command signal in the final packet.

The transmission of graphic contents may take a considerable amount of time (for example, more than an hour per monitor page frame) on the monitor of the terminal. Thus, it may be advantageous to transmit the data in an offset manner, via several satellites. The terminal may be constructed such that it stores an only partially transmitted command signal when switching off, and tries, when the terminal is switched on again, to complete the command signal and, if required, converts the complete command signal. The terminal may also be constructed such that it tries to already display partial contents; for example, it displays a keyword, such as “storm warning”, instead of a graphic content, even though graphic content has not yet been completely transmitted. It may be advantageous first to transmit the keywords and only then transmit the graphic content. The keyword can then be displayed ahead of time.

Other objects, advantages and novel features of the present invention will become apparent from the following detailed description of the invention when considered in conjunction with the accompanying diagrams.

### BRIEF DESCRIPTION OF THE DRAWINGS

The single FIGURE is a view of a satellite navigation system according to the present invention.

### DETAILED DESCRIPTION OF THE DRAWINGS

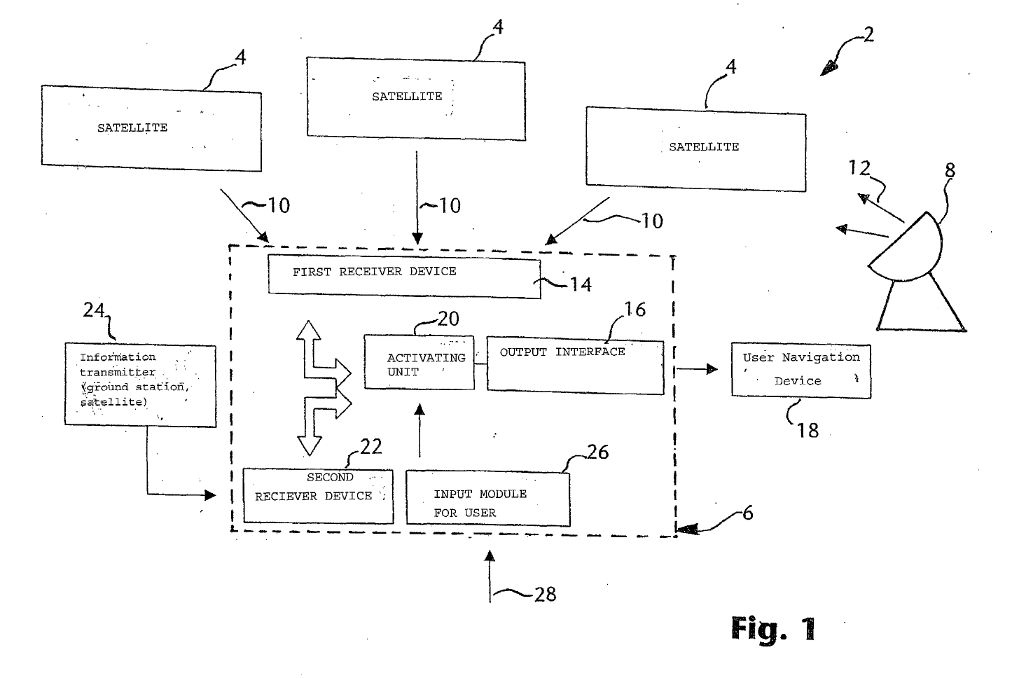

FIG. 1 illustrates a satellite navigation system 2 having several satellites 4 that emit navigation messages, a terminal 6, and a ground station 8 which is in contact with the satellite 4. The satellites 4, which continuously emit navigation messages, as illustrated by the arrows 10, are not geostationary but move on an inclined medium earth orbit (MEO=medium earth orbit). Thus, a satellite services a continuously changing region on the earth surface.

The ground station 8 checks, controls and synchronizes the operation of the satellites 4, and transmits corresponding signals to 4 them, as indicated by the arrows 12.

The terminal 6 is constructed for the use of satellite navigation services and has a first receiver 14 for receiving navigation messages emitted by the satellites 4. It also has an output interface 16 by which navigation information is provided to the user, as indicated by the user navigation data 18. Typically, the user navigation data are transmitted to a navigation device for further processing and for display on a monitor and/or for an acoustic indication.

Navigation messages received by the first receiver 14 are transmitted to an activating unit 20. The latter is constructed such that it recognizes a command signal that may be contained in the navigation message, and carries out or initiates corresponding actions. Correspondingly, it changes the operating condition of the terminal 6, for example, so that, information data are emitted via the output interface 16, information data are emitted in addition to the user navigation data 18.

The terminal 6 has a second receiver 22 which can receive information from an information transmitter 24 which may be, for example, be a ground station or another satellite. A relatively large bandwidth is preferably available between the information transmitter 14 and the second receiver 22 compared with the bandwidth between the satellite 4 and the first receiver 14. By way of this channel, relatively large quantities of data can be transmitted to the terminal 6 within a relatively short time period.

When it receives a corresponding command signal, which is part of a navigation message emitted by a satellite 4, the activating unit 20 activates the second receiver device 22, which may be part of a bidirectional communication device that actively queries information data from an information transmitter 24 from outside the terminal 6. The corresponding information source may be the internet, etc. The terminal 6 also has an input module for the user, the input of the user being represented by the arrow 28. The input module for the user may be constructed and coupled with the activating unit such that the terminal 6 will resume its normal operation only when, by way of the input module 26, the user acknowledges the changed operating condition of the terminal 6, thus, for example, the receiving of an information.

Many different types of information may be transmitted. For example, warnings of catastrophes, storms, traffic warnings, event information, advertisements, stock exchange prices, etc. may be emitted to the user as information. Alternatively, command signals and/or information may be transmitted that is not displayed to the user but is only processed in the terminal 6, for example, the downloading of new software, etc.

It is also conceivable that the terminal 6 (by way of the activating unit 20) first queries data that are specific to the terminal, the user and/or the user's environment before corresponding command signals from the activating unit will actually lead to the display of information, to the fetching of information, etc. Thus, for example, in the case of airplanes, ships or vehicles, a very targeted callback action can be carried out in that, for a example, first the vehicle type, the vehicle model, the vehicle number, the mileage, etc. are required before then finally a callback message is emitted to the user by way of the output interface 16. As a function of the movement pattern, speed, direction, etc., very specific information can be transmitted to the concerned user, such as individual and selective traffic information.

The transmitted command signals and/or information may have “expiration dates”, so that they are deleted from the memory as of a certain date or after a certain time.

In the FIGURE, the terminal 6 for the use of satellite navigation services is defined by a broken line. In addition to the components shown within this broken line, the terminal may also have other components, such as a memory, a power supply, a display device, etc. Some components (for example, the second receiver device 22), may also be constructed as separate accessories externally of the terminal 6. The individual components of the terminal 6 may be implemented, for example, by means of microprocessors. It is not necessary that all of the individual components of the terminal 6 are present in a mutually physically separate manner. On the contrary, the components may be implemented in one or more microprocessors.

The terminal 6 may also be designed so that the information is not automatically emitted by the activating unit to the output interface 16 and then to the user, but only when the user actively requests the corresponding information via of the user input module 26. As a result of the input of another command by way of the user input module 26, the navigation data can be emitted by way of the output interface 16. Instead of the manual input of the second command by way of the input module 26, this second command can also take place automatically in a time-shifted manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A terminal for satellite navigation services, said terminal comprising:
a first receiver for receiving navigation messages emitted by satellites;
an output interface for outputting navigation information; and
an activating unit which changes an operating state of the terminal, in response to a command signal contained in a navigation message.

2. The terminal according to claim 1, further comprising a second receiver device for receiving information data.

3. Terminal according to claim 2, wherein the second receiver device is an element of a communication device which is constructed such that it can actively queries information data from outside the terminal.

4. The terminal according to claim 1, wherein, the activating device can emit information data by way of the output interface.

5. The terminal according to claim 1, further having a user input module, wherein, after a change of the operating condition of the terminal, the activating device changes back into the normal operation only in response to a signal of the user input module.

6. The terminal according to claim 1, further comprising a memory for storing transmitted information data together with the navigation messages.

7. The terminal according to claim 6, wherein the activating unit manages the storing of the information data into the memory.

8. The terminal according to claim 1, wherein the activating unit responds only to defined command signals, as a function of the speed of the terminal determined by the terminal.

9. A satellite navigation system comprising a plurality of satellites that emit navigation messages,
at least one terminal and a ground station which is in contact with the satellites, wherein the at least one terminal comprises:
a first receiver for receiving navigation messages emitted by satellites;
an output interface for outputting navigation information; and
an activating unit which changes an operating state of the terminal, in response to a command signal contained in a navigation message.

10. The satellite navigation system according to claim 9, wherein:
the ground station has a selecting device that selects satellites which momentarily service a geographic region on the ground;
the navigation message of at least some of these satellites contains a command signal that can change the operating condition of a terminal in this region.

11. A method of changing an operating state of a terminal in a satellite navigation system, said method comprising:
generating a command signal;
transmitting the command signal to at least one satellite of the satellite navigation system;
incorporating the command signal into a navigation message of the satellite;
transmitting the navigation message containing the command signal to the terminal; and
changing the operating condition of the terminal in response to the command signal.

12. The method according to claim 11, further comprising selecting at least one satellite based on a target group to be reached.

13. A method according to claim 11, wherein the step of changing the operating condition of the terminal includes emitting information data.

14. The method according to claim 13, wherein the emission of information data includes emission of information data instead of navigation data.

15. The method according to claim 13, wherein the emission of information data includes the mission of information data in addition to the navigation data.

16. The method according to claim 11, wherein the step of changing the operating condition of the terminal includes receiving information data.

17. The method according to claim 16, further comprising actively fetching the information data from an information data source.

18. The method according to claim 11, further comprising resuming normal operation of the terminal after a change of the operating condition of the terminal, when the user has acknowledged the change of the operating condition.

19. The method according to claim 11, further comprising:
checking speed of the terminal; and
changing the operating state as a function of said speed.

20. A method of operating a satellite navigation system, comprising:
a satellite of said navigation system omitting a navigation message, wherein, in addition to the pure navigation data, said message includes at least one command signal for changing the operating condition of a terminal of said navigation system.
